(19) United States
(12) Patent Application Publication
(10) Pub. No.: US 2014/0022151 A1
(43) Pub. Date: Jan. 23, 2014

(54) Wireless Control for Configurable Organic LED (OLED)

(71) Applicant: TeleCommunication Systems, Inc., Annapolis, MD (US)

(72) Inventor: Michael Andrew Cuff, Clyde Hill, WA (US)

(21) Appl. No.: 13/940,860

(22) Filed: Jul. 12, 2013

Related U.S. Application Data
(60) Provisional application No. 61/674,616, filed on Jul. 23, 2012.

(51) Int. Cl. G09G 3/32

(52) U.S. Cl. CPC G09G 3/3208
USPC 345/81

(57) ABSTRACT

A mobile controller application for wirelessly controlling the non-structural appearance of a configurable organic light-emitting diode (OLED) object. A configurable OLED object is fitted with a flexible OLED, a power source, and one or more receptors. A mobile controller application instructs a mobile controller device to send signals, indicating a particular color or display pattern, to one or more receptors embedded in a configurable OLED object. An OLED object receives signals and updates it's non-structural display accordingly. A mobile controller application operates on a mobile controller device. A mobile controller device is preferably a mobile device conventionally used for cell network communication. A mobile controller application enables a user to preview, select, and transmit a display pattern to a configurable OLED object. The inventive mobile controller application also enables a user to store, browse, edit, search, import, export, and categorize display options, which are maintained in a local image database.

The present application claims priority from U.S. Provisional No. 61/674,616, entitled “Wireless Control for Configurable Organic LED (OLED)”, filed Jul. 23, 2012, the entirety of which being expressly incorporated herein by reference.

### BACKGROUND OF THE INVENTION

1. Field of the Invention

This invention relates generally to organic light emitting diode products (OLED).

2. Background of Related Art

Certain individuals may own several items (e.g. garments, computer cases, purses, backpacks, etc.) that are identical in structure but different in color and display pattern, only. For instance, certain individuals may own several variations of the same shoe to meet color and display pattern requirements. Unfortunately, owning the same shoe in several different color variations may pose a storage problem and/or a transfer problem. For instance, if one wanted to travel with 10 different pairs of shoes, packing may become an issue.

Moreover, while an individual may purchase several structurally identical shoes to meet color and display pattern requirements, it is less likely that an individual would buy several variations of a more substantial item, such as a car or a house, to meet color and display pattern requirements. Therefore, to alter the display pattern or color of a more substantial item, such as a car or a wall in a house, the non-structural display of that item must be permanently altered by, e.g., repainting or re-wallpapering the item.

### BRIEF DESCRIPTION OF THE DRAWINGS

Features and advantages of the present invention will become apparent to those skilled in the art from the following description with reference to the drawings, in which:

FIG. 1 depicts an exemplary configurable OLED object, in accordance with the principles of the present invention.

FIG. 2 depicts an exemplary schematic of a mobile controller application, in accordance with the principles of the present invention.

FIG. 3 depicts exemplary import/export abilities provided on a mobile controller application, in accordance with the principles of the present invention.

FIG. 4 depicts an exemplary process of wirelessly controlling the non-structural appearance of a configurable OLED object via a mobile controller application, in accordance with the principles of the present invention.

### SUMMARY OF THE INVENTION

A method and apparatus for wirelessly controlling the non-structural appearance of a configurable organic light-emitting diode (OLED) object, comprises a mobile controller application. In accordance with the principles of the present invention, a mobile controller application solves the problem of a permanent color, pattern, and/or general non-structure related display assigned to an object (e.g. a garment or hand bag) upon manufacture.

In accordance with the principles of the present invention, a configurable organic light-emitting diode (OLED) object is any object fitted with a flexible OLED, a power source, and one or more receptors (e.g. infrared signal receptors) that are capable of receiving signals (e.g. infrared signals) from the inventive mobile controller application.

A mobile controller application operates on a mobile controller device. A mobile controller device is preferably a mobile device conventionally used for cell network communication, e.g., a smart phone. In another embodiment, a mobile controller device is a special dedicated remote controller.

To alter the non-structural appearance of a configurable OLED object, a mobile controller application instructs a mobile controller device to send signals (e.g. pulse infrared signals), indicating a particular color or display pattern, to one or more tiny receptors (e.g. infrared signal receptors) embedded in the configurable OLED object. The OLED object receives the signals and updates it's OLED display accordingly.

In accordance with the principles of the present invention, a mobile controller application enables a user to preview, select, and transmit a desired display pattern (e.g. color, graphic, pattern, etc.) to a configurable OLED object. The inventive mobile controller application also provides options to enable a user to store, browse, edit, search, import, export, and categorize display pattern files. Display pattern files are stored in a local image database on a mobile controller device.

### DETAILED DESCRIPTION OF ILLUSTRATIVE EMBODIMENTS

The present invention provides a mobile controller application that controls the non-structural appearance (e.g. color, graphic, pattern, etc.) of a configurable organic light-emitting diode (OLED) object, to solve the problem of a permanent color, pattern, and/or general non-structure related display assigned to an object (e.g. a garment or hand bag) upon manufacture.

In accordance with the principles of the present invention, a configurable OLED object is any object fitted with a flexible OLED, a power source, and a receptor, or set of receptors (e.g. infrared signal receptors), capable of receiving signals (e.g. infrared signals) from a mobile controller application.

An existing OLED is a light-emitting diode (LED) (i.e. a light source) that comprises a layer of organic compounds positioned between two electrodes. A layer of organic compounds within an OLED emits light when an electric current is applied to it. OLEDs are thinner and emit a more vivid color than conventional LEDs.

A flexible OLED is an OLED constructed on a flexible piece of plastic. Fitting an OLED on a flexible piece of plastic enables the OLED to bend and take shape.

Exemplary configurable OLED objects, in accordance with the principles of the present invention, include: shoes, garments, phone cases, computer cases, walls, automobile paneling, hand bags, backpacks, etc.

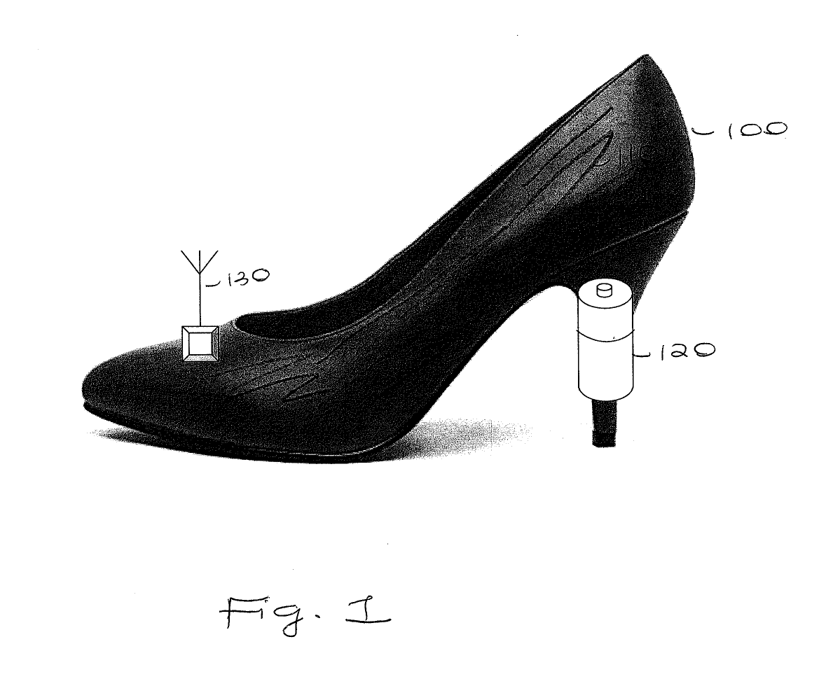

FIG. 1 depicts an exemplary configurable OLED object, in accordance with the principles of the present invention.

In particular, the OLED object 100 depicted in FIG. 1 is a high heeled shoe fitted with a flexible OLED fabric 110, a power source 120, and a receptor (e.g. an infrared signal receptor) 130, capable of receiving signals (e.g. infrared pulse signals) from the inventive mobile controller application. A high heeled shoe is an easy candidate for a configurable OLED object 100, since a flexible OLED 110 may easily be fitted thereto. Likewise, a heel lift is an ideal location for a battery 120. Shoes are also typically not washed, which helps to minimize the possibility of water damage.

Different types of OLED objects 100 require different methods for fitting a flexible OLED 110, a power source 120, and one or more signal receptors 130. Hence, the present invention is not targeted to the manufacture of OLED objects 100, but rather to the mobile controller application used to alter the non-structural appearance of a configurable OLED object 100.

In accordance with the principles of the present invention, a mobile controller application is operative on a mobile controller device. In a preferable embodiment, a mobile controller device is a mobile device conventionally used for cell network communication, e.g., a smart phone, a wireless computer device, etc. In another embodiment, a mobile controller device is a special dedicated remote controller.

A mobile controller application controls the non-structural appearance of a configurable OLED object 100 by instructing a mobile controller device to send signals (e.g. pulse infrared signals), indicating a particular display pattern (e.g. color, graphic, pattern, etc.), to one or more tiny receptors (e.g. infrared signal receptors) embedded in the configurable OLED object 100. The configurable OLED object 100 uses existing OLED technology to display the color, pattern, graphic, etc., (static or dynamic) indicated by signals received thereon. Thus, a mobile controller application (on a mobile controller device) controls the non-structural appearance of a configurable OLED object 100 much like a remote controller controls a channel displayed on a W. Only, instead of changing channels, a mobile controller application changes the appearance of a configurable OLED object 100.

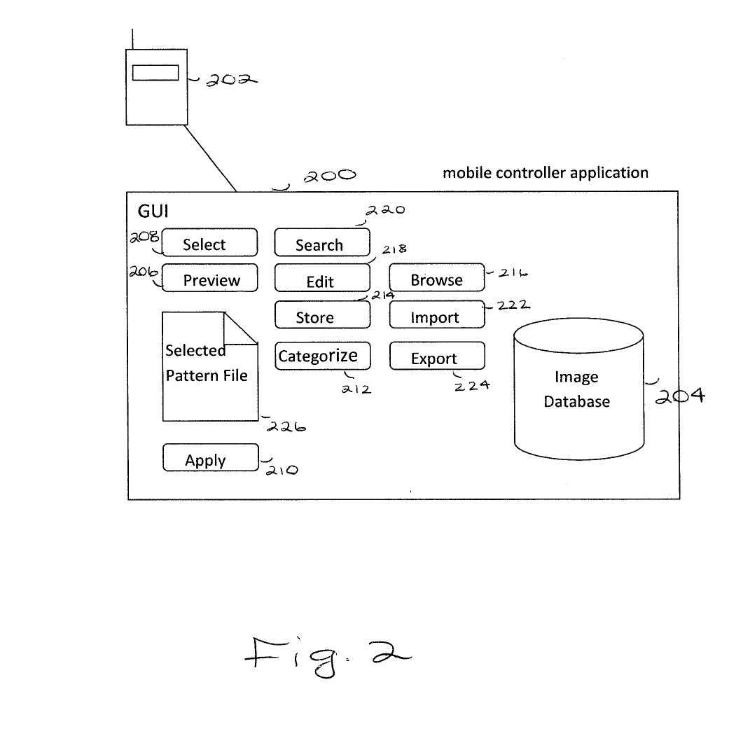

FIG. 2 depicts an exemplary schematic of a mobile controller application, in accordance with the principles of the present invention.

As depicted in FIG. 2, a mobile controller application 200 is operative on a mobile controller device 202. Moreover, a mobile controller application 200 stores display patterns, colors, graphics, etc., in a local image database 204. By storing display pattern files locally, the mobile controller application 200 is able to provide options to enable a user to preview 206, select 208, and/or transmit 210 a desired display pattern 226 (e.g. color, graphic, pattern, etc.) to a configurable OLED object 100. The inventive mobile controller application 200 additionally provides options to enable a user to store 214, browse 216, edit 218, search 220, import 222, export 224, and categorize 212 display pattern files. Import/export 222/224 abilities enable a user to trade, customize, and/or design new display patterns.

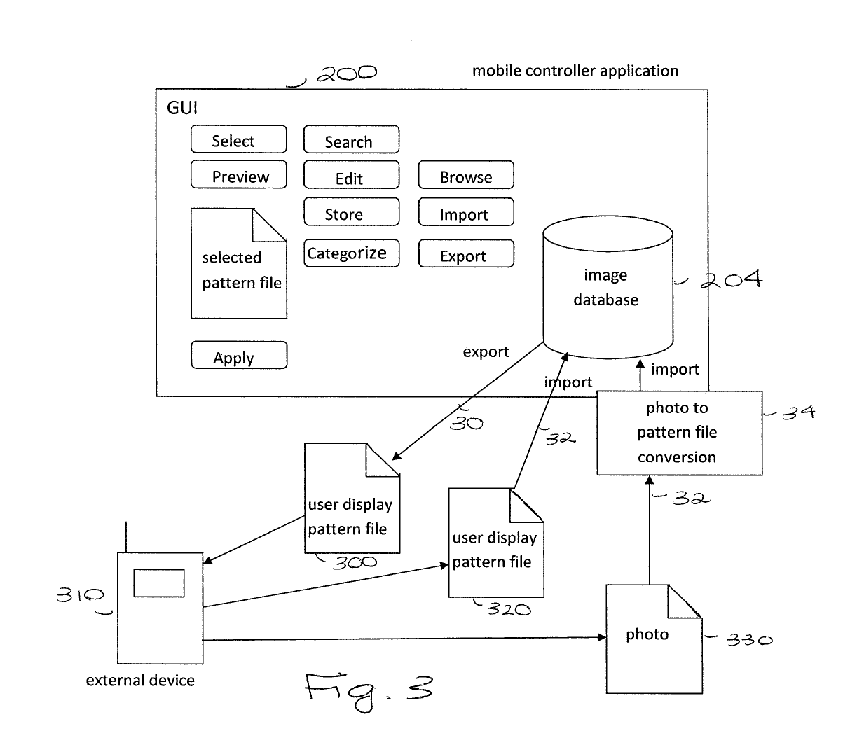

FIG. 3 depicts exemplary import/export abilities provided on a mobile controller application, in accordance with the principles of the present invention. As depicted in FIG. 3, a user display pattern file 300 stored in a local image database 204 may be exported 30 to an external device 310. Similarly, a user display pattern file 320 and/or a photo 330 stored on an external device 310 may be imported 32 to a local image database 204. As depicted in FIG. 3, an imported photo 330 first undergoes a photo to pattern file conversion 34, before being stored in a local image database 204.

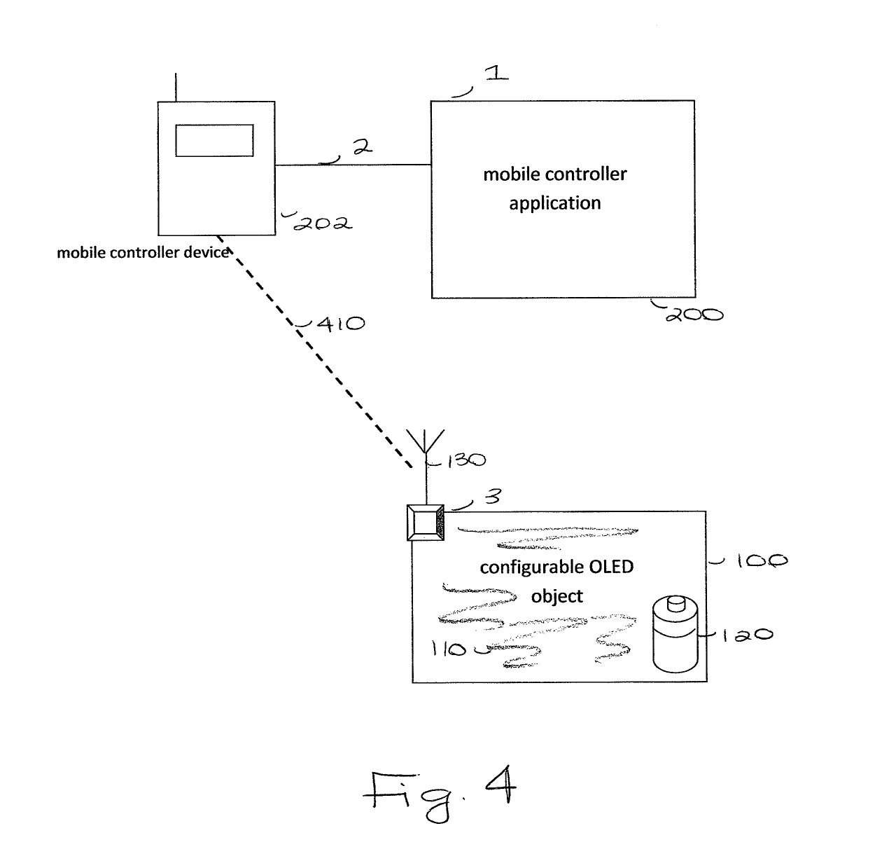

FIG. 4 depicts an exemplary process of wirelessly controlling the non-structural appearance of a configurable OLED object via a mobile controller application, in accordance with the principles of the present invention.

As depicted in step 1 of FIG. 4, a user uses options 206-224 provided on a mobile controller application 200 to select a display pattern (e.g. color, graphic, pattern, etc.) for a configurable OLED object 100 (e.g. a high heeled shoe fitted with a flexible OLED fabric 110, a power source 120, and a sensor 130). As portrayed in step 2, the mobile controller application 200 instructs the mobile controller device 202 to transit infrared pulse signals 410 (infrared signals are small and affordable but other protocols may also be used) based on the display pattern selected, to the configurable OLED object 100. As depicted in step 3, the OLED object 100 receives pulse infrared signals 410 via an infrared signal receptor 130 embedded therein, and updates it's OLED 110 display pattern accordingly.

In accordance with the principles of the present invention, all configurable OLED objects 100 are controlled in non-structural appearance, wirelessly, by a mobile controller application 200 operating on a mobile controller device 202. A user uses options 206-224 provided by a mobile controller application 200 to select a color, pattern, graphic, etc., to be transmitted to a configurable OLED object 100 for display.

Software drivers enable as many devices as possible to function like a mobile controller device 202 without having to undergo hardware changes.

Nearly any object can be an OLED object 100, as defined within the present invention. An object need only an OLED 110, a power source 120, and one or more sensors (e.g. infrared sensors) 130.

The present invention solves the need for an individual to own several structurally identical items to meet color and display pattern requirements. For example, rather than owning 10 structurally identical shoes in 10 different colors, an individual may own just one pair of shoes that is a configurable OLED object, capable of displaying every possible color and display pattern conceivable via use of the inventive mobile controller application. The present invention additionally solves certain storage problems, since it enables users to replace several variations of an item with one configurable item.

Moreover, the present invention may provide uniform management for safety patrol. For instance, each police jurisdiction typically wears a different color uniform, e.g., a different color vest. In accordance with the principles of the present invention, rather than owning a separate vest for each jurisdiction, an officer working multiple jurisdictions could wear a vest that is a configurable OLED object, and simply update the display of the vest based on a current jurisdiction.

The present invention may be used to provide safety apparel for improved visibility. In particular, a configurable OLED object 100 could be used to display custom dynamic images, such as flashes of orange, red, yellow, or whatever is deemed best for hazardous work situations, such as roadside construction.

The present invention may also be used to provide dynamic camouflage for hunters and soldiers. In particular, when wearing camouflage that is a configurable OLED object 100, a user may easily switch from tree bark camouflage to snow field camouflage, if need be, in the same manner that one would change a channel on a TV.

The present invention may be applied to structure, machines, and clothing. Photos capturing an existing environment can be imported into a mobile controller application 200, translated into a display pattern (via a photo to pattern file conversion), and sent to a configurable OLED object 100 for display.

The present invention may also be used for military equipment display. For instance, code communication transmission could be performed directly on a soldier's garment, rather than on a separate communication device, to take hands on communication to the next level.

The present invention is additionally applicable to high end fashion minded consumers willing to buy expensive clothes for aesthetic purposes or for the purpose of attaining a flexible, configurable appearance. The invention provides the ability to control and alter an OLED display on an object 100 fitted with an OLED 110.

Network telephony need not be included within the present invention.

While the invention has been described with reference to the exemplary embodiments thereof, those skilled in the art will be able to make various modifications to the described embodiments of the invention without departing from the true spirit and scope of the invention.

What is claimed is:

1. A method of changing a visual appearance of a flexible object, comprising:
mounting a configurable organic light-emitting diode (OLED) layer on said object;
controlling said configurable OLED layer to display a selected image to give said object a first visual appearance of said flexible object;
receiving a control signal to change said visual appearance of said flexible object; and
updating said visual appearance of said flexible object to display a new image according to said received control signal.

2. The method of changing a visual appearance of a flexible object according to claim 1, wherein:
said control signal is received wirelessly.

3. The method of changing a visual appearance of a flexible object according to claim 1, further comprising:
a wireless controller device.

4. The method of changing a visual appearance of a flexible object according to claim 3, further comprising:
storing said selected image locally in said wireless controller device.

5. The method of changing a visual appearance of a flexible object according to claim 1, wherein:
said received control signal is a pulsed infrared signal.

6. The method of changing a visual appearance of a flexible object according to claim 1, wherein:
said selected image includes at least three different colors.

7. The method of changing a visual appearance of a flexible object according to claim 1, wherein:
said selected image is a pattern.

8. The method of changing a visual appearance of a flexible object according to claim 1, wherein:
said selected image is photographic.

9. The method of changing a visual appearance of a flexible object according to claim 3, further comprising:
exporting said selected image from said wireless controller device.

10. The method of changing a visual appearance of a flexible object according to claim 1, further comprising:
converting a photographic image into a pattern image for use as said selected image.

11. Apparatus for changing a visual appearance of a flexible object, comprising:
means for mounting a configurable organic light-emitting diode (OLED) layer on said object;
means for controlling said configurable OLED layer to display a selected image to give said object a first visual appearance of said flexible object;
means for receiving a control signal to change said visual appearance of said flexible object; and
means for updating said visual appearance of said flexible object to display a new image according to said received control signal.

12. The apparatus for changing a visual appearance of a flexible object according to claim 11, wherein:
said control signal is a wireless control signal.

13. The apparatus for changing a visual appearance of a flexible object according to claim 11, further comprising:
a wireless controller device.

14. The apparatus for changing a visual appearance of a flexible object according to claim 11, wherein:
said selected image is stored locally in said wireless controller device.

15. The apparatus for changing a visual appearance of a flexible object according to claim 11, wherein:
said received control signal is a pulsed infrared signal.

16. The apparatus for changing a visual appearance of a flexible object according to claim 11, wherein said configurable OLED layer on said object comprises:
an OLED;
a power source; and
a signal receptor.

17. The apparatus for changing a visual appearance of a flexible object according to claim 11, wherein:
said selected image includes at least three different colors.

18. The apparatus for changing a visual appearance of a flexible object according to claim 11, wherein:
said selected image is a pattern.

19. The apparatus for changing a visual appearance of a flexible object according to claim 11, wherein:
said selected image is photographic.

20. The apparatus for changing a visual appearance of a flexible object according to claim 11, further comprising:
a converter to convert a photographic image into a pattern image for use as said selected image.
